(19) United States
(12) Patent Application Publication
(10) Pub. No.: US 2006/0048451 A1
(43) Pub. Date: Mar. 9, 2006

(54) Vehicle control system for a power gate

(75) Inventors: Tomohiro Fukumura, Rochester Hills, MI (US); Brian J. Marlett, Shelby Township, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/887,612

(22) Filed: Jul. 8, 2004

Related U.S. Application Data
(60) Provisional application No. 60/485,947, filed on Jul. 9, 2003.
(60) Provisional application No. 60/497,540, filed on Aug. 25, 2003.

(51) Int. Cl. E05F 11/00

(52) U.S. Cl. 49/360

(57) ABSTRACT

A control system has a sensor for monitoring a vehicle gate condition. A control unit receives an output from the sensor and controls a motorized drive. The motorized drive changes the vehicle gage condition from an open condition to a secured condition. The unit control has an automated state that causes operation of the motorized drive and a disabled state disabling operation of the motorized drive. The control unit is programmed to change from the disabled state to the automated state upon a predetermined condition relating to the output from the sensor.

### CROSS REFERENCE TO RELATED APPLICATIONS

This patent application claims priority to U.S. Provisional Patent Application Ser. No. 60/485,947 filed on Jul. 9, 2003 and to U.S. Provisional Patent Application Ser. No. 60/497,540 filed on Aug. 25, 2003.

### BACKGROUND OF THE INVENTION

This invention relates to a control system for a power gate.

A motor vehicle, such as an automobile, truck or sports utility vehicle, may have a motorized drive that automatically opens or closes the gate at the touch of a button on the vehicle or on a remote transmitter. The gate may be a door, a lift gate, a sliding door or other closure over an entry opening of the vehicle. The power gate may also have a power latch that secures the gate to the vehicle. When the gate reaches a position near its closed position, the latch on the gate engages a bolt on the vehicle to partially lock the latch. A motor associated with the latch then drives the gate to its closed position and then fully locks the latch.

Once the power gate is actuated, it is driven automatically to this closed and secured position. There are instances where the power latch may accidentally be placed in a partially locked condition, such as due to the vibration of the moving gate or from incidental contact. In such situations, the bolt on the vehicle cannot engage the latch. Consequently, the latch may not only fail to lock completely but also may prevent closure of the vehicle gate.

In addition, occasions may arise where an object may be caught in the path of the closing gate or latch. In such circumstances, it is desirable to disable the automated closure features of such power systems. Such automated features are also desirable to disable when a vehicle operator chooses to override automatic closure of the vehicle gate. For example, a vehicle operator may initially close the vehicle gage by touch of a button and then wish to close the gate manually. If the vehicle operator fails to use sufficient force to close the vehicle gate, the gate will then be left open and unlocked.

Accordingly, there is a need for a control system that prevents the foregoing problems associated with the automatic closure of a power gate and latch.

### SUMMARY OF THE INVENTION

The invention comprises a control system for a vehicle gate. The control system has a sensor that monitors a vehicle gate condition, such as the speed and position of the vehicle gate. This sensor provides an output to a control unit, which controls operation of a motorized drive that is linked to an operation of the vehicle gate. The motorized drive may drive the opening and closing of the vehicle gate or drive the opening and closing of a latch on the vehicle gate.

The inventive control system has an automated state and a disabled state. The automated state allows operation of the motorized drive while the disabled state disables operation of the motorized drive. The control unit is programmed to change from the disabled state to the automated state upon a meeting of a predetermined condition. The predetermined condition is related to an output of the sensor. In this way, the inventive control system allows for the intelligent operation of the vehicle gate and the vehicle latch.

The control system may be specifically designed to control a vehicle latch. In such an instance, a sensor monitors the vehicle gate to determine whether the vehicle gate is opening or closing. A control unit receives an output from the sensor and controls a motorized drive linked to the vehicle latch. The control unit has an automated state and a disabled state and allows the system to change from a disabled state to an automated state only when a predetermined condition is met. The predetermined condition is related to an output of the sensor.

In addition, the invention may be specifically applied to a powered vehicle gate. A sensor monitors vehicle gate speed and feeds this information to a control unit. In the event the vehicle gate does not exceed a minimum target speed, a speed sufficient to ensure the vehicle gate will close completely, the control system takes over operation of the vehicle gate and drives the vehicle gate to closure. In this manner, the automated closure feature is reenabled to ensure that the vehicle gate is fully secured.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a schematic view of the inventive control system, including sensor, control unit, motorized drive and vehicle gate in the closed position.

FIG. 2 illustrates the inventive control system of FIG. 1 with vehicle gate in the open position.

FIG. 2A illustrates a power vehicle latch of the inventive control system of FIGS. 1 and 2 in an open condition.

FIG. 2B illustrates the latch of FIG. 2A in a partially latched condition.

FIG. 2C illustrates the latch of FIGS. 2A and 2B in the fully latched condition.

FIG. 3 illustrates a table for determining a vehicle gate condition for the inventive control system.

FIG. 4 illustrates a table of conditions that shows when power operation of a vehicle latch of the inventive control system should be enabled.

FIG. 5 illustrates another table of conditions that shows when power operation of the vehicle latch should be enabled.

FIG. 6 illustrates another feature of the inventive control system relating to the vehicle latch.

FIG. 7 illustrates a table of conditions for operating both a vehicle power latch and vehicle power gate.

FIG. 8 illustrates a chart of the overall operation of the power vehicle gate by the inventive control system.

FIG. 9 illustrates a chart of how the inventive control system determines when power operation of the vehicle gate has been overrided.

FIG. 10 illustrates a chart of how the inventive control system determines when power operation of the vehicle gate shall be enabled.

### DETAILED DESCRIPTION OF THE PREFERRED EMBODIMENT

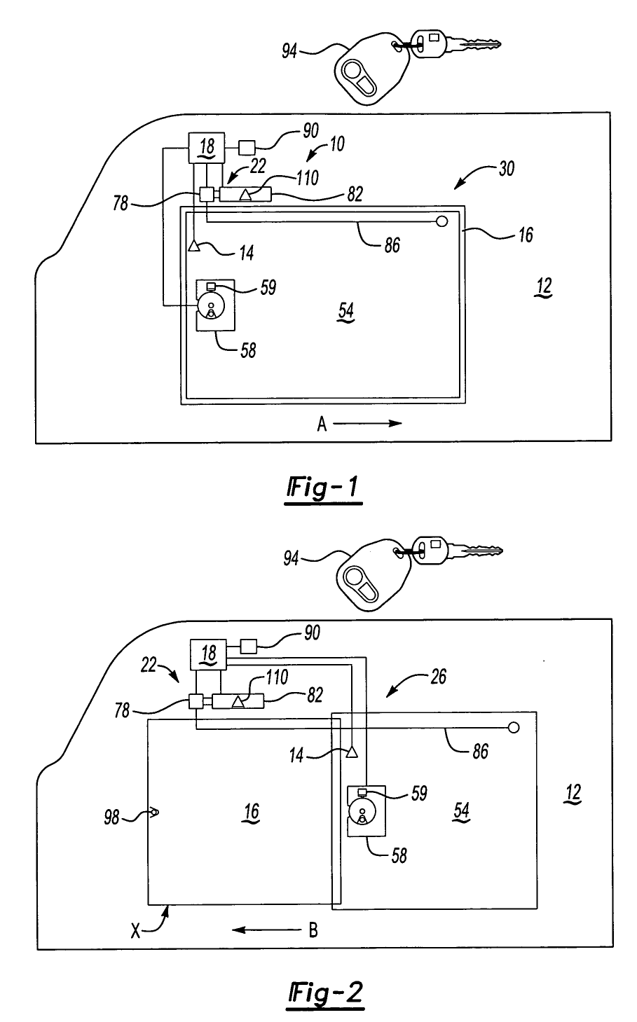

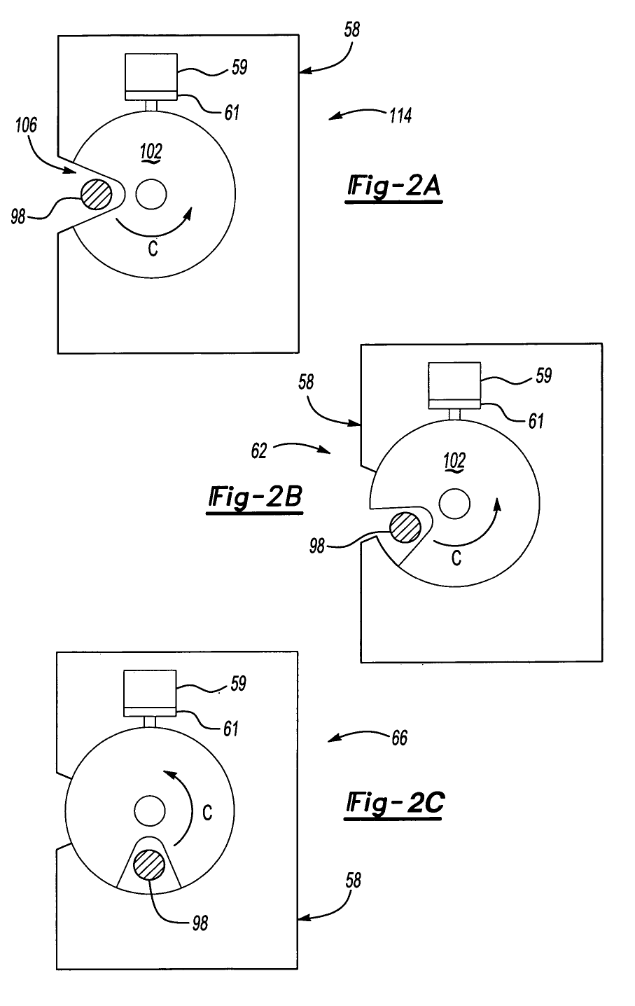

Inventive control system 10 is shown incorporated on vehicle 12. Vehicle 12 has vehicle gate 54 that opens and closes opening 16. As known, vehicle gate 54 is powered by motorized drive 22 to open and close automatically at the touch of a button, say button 90, which may be located on vehicle 12 or a remote transmitter 94, which may be on a key fob as shown. Motorized drive 22 has motor 82 and clutch 78. Motor 82 is mechanically linked to clutch 78. Clutch 78 is linked to cable 86, which is attached to vehicle gate 54. Vehicle gate 54 may be a vehicle door, a vehicle lift gate, a power sliding door, or other closure that covers an entryway for vehicle 12. In addition, vehicle gate 54 has vehicle latch 58, which itself is powered by vehicle latch motor 59. Operation of both vehicle gate 54 and vehicle latch 58 is controlled by control unit 18. The normal operation of vehicle gate 54 will now be explained with reference to FIGS. 1 and 2.

FIG. 1 illustrates vehicle gate 54 in a secured state 38. Vehicle gate 54 may be disposed completely over vehicle opening 16. Further, vehicle latch 58 may also be entirely locked. In the event a vehicle operator desires to open vehicle gate 54, the operator touches button 90 on vehicle 12 or, alternatively, uses remote transmitter 94 to signal control unit 18 to open vehicle gate 54. If vehicle latch 58 is locked, control unit 18 then instructs vehicle latch 58 to unlock by controlling vehicle latch motor 59 to drive vehicle latch 58 to open condition 114 (shown in FIG. 2A). Control unit 18 then instructs motorized drive 22 to drive cable 86 to open vehicle gate 54 in the direction of arrow A to the open position shown in FIG. 2.

To close vehicle gate 54, button 90 or remote transmitter 94 may be actuated again. Control unit 18 then controls motorized drive 22 to drive and vehicle gate 54 through cable 86 in the direction of arrow B to the closed position in FIG. 1. As vehicle gate 54 closes, vehicle latch 58 approaches latch bolt 98. When vehicle gate 54 has reached point X, a threshold position, latch bolt 98 is received within opening 106 of claw 102 as shown in FIG. 2A. Further movement of vehicle gate 54 in the direction of arrow B causes latch bolt 98 to move claw 102 in the direction of arrow C to the position shown in FIG. 2B. At this position, vehicle latch 58 is in partially latched condition 62. Control unit 18 then directs vehicle latch motor 59 to rotate further in the direction of arrow C to the fully latched position 66 shown in FIG. 2C to thereby lock vehicle latch 58. This action also closes vehicle gate 54 to the position shown in FIG. 1.

A problem with existing powered latch assemblies occurs when a vehicle latch enters into partially latched condition 62 (see FIG. 2B) before vehicle gate 54 has moved to position X. An object, such as a finger, may inadvertently move claw 102 to this position and thereby cause vehicle latch motor 59 to trigger so that claw 102 moves in the direction of arrow C to pinch the object. In addition, claw 102 may rotate to the partially latched position of FIG. 2B due to vibrations from vehicle gate 54 if vehicle gate 54 is a lift gate, for example. Typically, control unit 18 is programmed to maintain claw 102 in this partially latched condition 62 until triggered. In this position, latch bolt 98 will be unable to enter opening 106 to trigger claw 102 to move to the fully latched position of FIG. 2C. Inventive control system 10 addresses these problems in the following manner.

Specifically, control system 10 has sensor 14, which monitors vehicle gate 54. Sensor 14, a position and/or speed sensor, is used to determine a vehicle gate condition, such as whether the vehicle gate 54 is in open condition 26, a position to the right of position X as shown in FIG. 2, or an ajar position at position X. Sensor 14 may be a pair of encoder sensors or Hall effect sensors. In addition, sensor 110 determines whether vehicle gate 54 is opening or closing. Both sensor 14 and sensor 110 provide an output relating to a condition of vehicle gate 54 to control unit 18. In this way, control unit 18 receives output from sensors 14 and 110 to determine whether vehicle gate should automatically close or whether this automated state should be disabled.

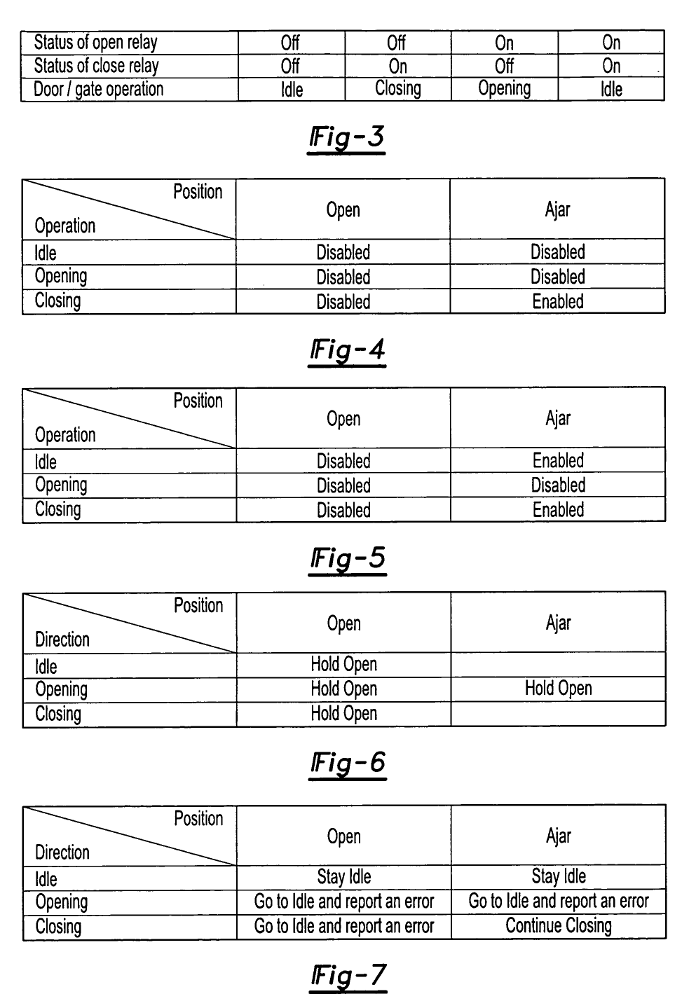

Sensor 110 may be a sensor that monitors the rotational movement of motor 82, such as by encoder sensors or Hall effect sensors. In addition, sensor 110 may determine the operational status of motor 82 by examining whether power relays associated with motor 82 are activated. As shown in FIG. 3, if the relay for opening vehicle gate 54 is off and the relay for closing vehicle gate 54 is off, then control unit 18 determines that vehicle gate 54 is idle. If the open relay is off and the closed relay is on, then control unit 18 determines that vehicle gate 54 is closing. On the other hand, if the open relay is on and the closed relay is off, control unit 18 determines that the vehicle gate 54 is opening. Finally, if both relays are on, vehicle 54 is also presumed to be idle.

Essentially, only if vehicle gate 54 is determined to be closing and the vehicle gate position is determined to be ajar, at position X, is power operation of vehicle latch 58 used. Hence, vehicle latch motor 59 is disabled from operation until these predetermined conditions are met. Once they are met, control unit 18 automatically drives vehicle latch motor 59 to fully close vehicle gate 54 and lock vehicle latch 58 to secured condition 30. These conditions are shown in FIG. 4. As further shown, when vehicle gate 54 is determined to be in open condition 26, control unit 18 disables its automated closing feature provided by vehicle latch motor 59. Only when vehicle gate 54 is determined to be at position X, that is ajar, and vehicle gate 54 is determined to be closing, is the automated feature of control unit 18 enabled following actuation of button 90 or remote transmitter 94.

There may be instances where it is desirable to incorporate the inventive features of control system 10 for the manual closing of vehicle gate 54. For example, in the event button 90 or remote transmitter 94 are not actuated, a vehicle operator may close vehicle gate 54 manually. Control system 10 may be used so that the automated state for closing vehicle gate 54 is enabled at the point where vehicle gate 54 is manually pulled closed in the direction of arrow B to the ajar position, position X shown in FIG. 2. At this point, control unit 18 then powers vehicle latch motor 59 to rotate claw 102 in the direction of arrow C from partially latched condition 62 shown in FIG. 2B to fully latched condition 66 shown in FIG. 2C. This feature is illustrated by FIG. 5. As shown, during manual operation, control unit 18 disables its automated closing feature when vehicle gate 54 is determined to be in open condition 26. When vehicle gate 54 is ajar, at position X, control unit 18 then determines the status of operation of motorized drive 22. If motorized drive 22 is idle, then control unit 18 drives vehicle latch motor 59 to fully secure latch bolt 98 within claw 102 to fully latched condition 66 shown in FIG. 2C. Of course, if motorized drive 22 is subsequently actuated by button 90 or remote transmitter 94, then when vehicle gate 54 reaches the ajar position, position X, control unit 18 also drives vehicle latch motor 59 to drive vehicle latch 58 to fully latched condition 66.

FIG. 6 illustrates another inventive feature of control system 10. Control system 10 has a feature that holds vehicle latch 58 in open condition 114 shown in FIG. 2A. In this way, vehicle latch 58 will not enter into partially latched condition 62 shown in FIG. 2B. Such a feature prevents vehicle latch 58 from being placed in a position where it cannot engage latch bolt 98. Specifically, claw 102 is held in open condition 114 shown in FIG. 2A when vehicle gate 54 is determined to be in open condition 26. In addition, when vehicle gate 54 is determined to be ajar, claw 102 is held in open condition 114 if motorized drive 22 is determined to be opening. In other instances, vehicle latch 58 is allowed to proceed to partially latched condition 62.

This hold open feature is accomplished by maintaining claw 102 in the open condition 114, shown in FIG. 2A. For example, vehicle latch 58 may have a detent or pawl, which is released continuously so that claw 102 releases latch bolt 98 continuously as well. In addition, vehicle latch motor 59 may have a latch clutch 61. Latch clutch 61 is then engaged to hold claw 102 in open condition 114 shown in FIG. 2A.

Moreover, as shown in FIG. 7, control system 10 may control vehicle latch 58 in conjunction with the power closing of vehicle gate 54. For example, if vehicle latch 58 enters partially latched condition 62, vehicle gate 58 is determined to be closing and ajar, control unit 18 continues to close vehicle gate 54. If vehicle latch 58 enters partially latched condition 62 while motorized drive 22 is idle, then control unit 18 will continue to idle motorized drive 22. Also, if vehicle latch 58 enters partially latched condition 62 while vehicle gate 54 is judged opening or closing with vehicle gate 54 still open, control unit 18 will stop motorized drive 22 and report an error. These actions are summarized in FIG. 7.

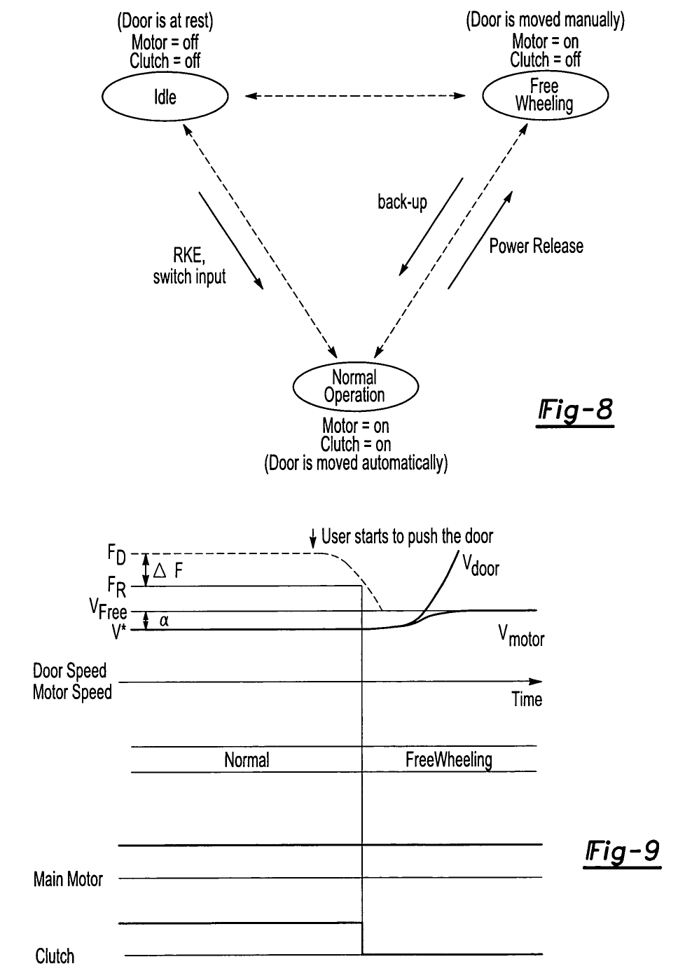

FIGS. 8-10 illustrate another inventive aspect of inventive control system 10. Following actuation of control unit 18 by button 90 or remote transmitter 94 to close vehicle gate 54, there may be instances where a vehicle operator wishes to take control over the closing of vehicle gate 54. Typically, the vehicle operator wishes to close vehicle gate 54 faster than the speed at which vehicle gate 54 closes when powered by motorized drive 22. In the past, the automated closure feature was simply disabled when the vehicle operator touched the door handle. However, if the vehicle operator fails to close vehicle gate 54 with enough speed or force, vehicle gate 54 may remain open, causing the operator the inconvenience of having to close the gate again.

Rather than simply disable completely motorized drive 22, control system 10 simply decouples motor 82 from cable 86 through clutch 78. Motor 82 is kept running or free wheeling. In the event control unit 18 determines through sensor 14 that the speed of vehicle gate 54 is below a predetermined threshold to ensure closure, i.e., target speed, then control unit 18 recouples cable 86 to motor 82 to take over and power the closing of vehicle gate 54. In this way, if the vehicle operator does not close vehicle gate 54 with sufficient speed, control unit 18 resumes powering vehicle gate 54.

FIG. 8 illustrates this feature. When motor 82 is off and clutch 78 is off, control unit 18 is idle. In the event of either a remote transmission or switch input from remote transmitter 94 or button 90, then both motor 82 and clutch 78 are activated and vehicle gate 58 is moved automatically. When a user takes over operation of the closing of the vehicle gate 54, then motor 82 is kept running while clutch 78 is disengaged. If control unit 18 takes over closing a vehicle gate 54, then from this position, clutch 78 is reengaged to close vehicle gate 54 during normal operation.

Generally, control unit 18 is in idle mode waiting for an open or close request from remote transmitter 94 or button 90. In the event of such a request, control unit 18 opens or closes the door during a normal operation mode. During normal operation mode, control unit 18 monitors the force F_{D} required to move vehicle gate 54, which should be the force required to move vehicle gate 54 at target speed V*. This force may be determined by sensor 14, which may also monitor changes in vehicle gate speed in addition to vehicle gate position. Control unit 18 compares force F_{D} with a reference force F_{R} stored in memory. Also, instead of force, control unit 18 may monitor speed of vehicle gate V_{Door} and compare this speed to target speed V*.

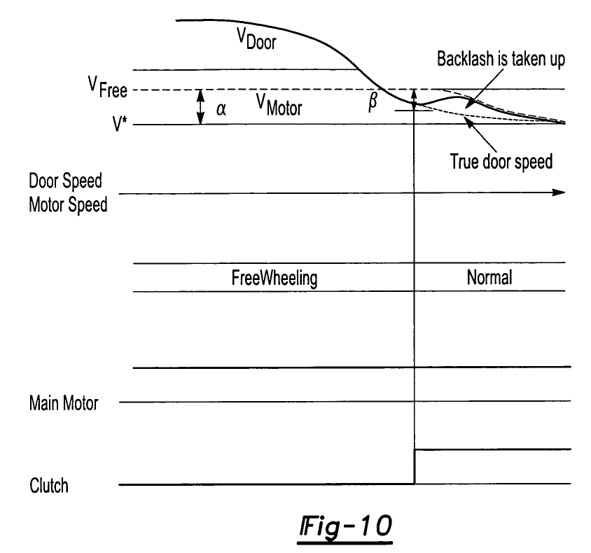

As shown in FIG. 9, if the detected force F_{D} is lower than the reference force F_{R} by more than a predetermined threshold, say ΔF, control unit 18 determines that a vehicle operator is using his own force and wishes to move vehicle gate 54 manually. Control unit 18 then disengages clutch 78 from motor 82 but continues to run motor 82. Preferably, motor 82 is kept running at a free wheeling speed V_{Free} higher than the target door speed, V* by a certain amount a to ensure that any slack in cable 86 is taken up to prevent vehicle gate 54 from shuddering.

As shown in FIG. 10, if vehicle gate 54 travels at a speed V_{Door} smaller than the speed of motor 82, at this point V_{Free} by more than an amount β, control unit 18 goes back to normal run mode and reengages clutch 78 to take back control of movement of vehicle gate 54. Here, amount β is set smaller than amount a so that clutch 78 gets engaged when vehicle gate speed V_{Door} is faster than target speed V*. As further shown in FIG. 10, the driven shaft of clutch 78 takes up speed because it is slower than the drive shaft when engaged. On the other hand, the true vehicle gate speed continues to decrease because neither the vehicle operator nor motor 82 moves it. Hence, the difference between the two speeds means that the system is taking up slack. When the two speeds become equal, the system has taken up all the slack. Once clutch 78 is engaged, the speed of motor 82 V_{Motor} is gradually reduced by control unit 18 to the target door speed V*. In this way, vehicle gate 18 reaches its target speed smoothly.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A control system for a vehicle gate, comprising:
a sensor for monitoring a vehicle condition;
a control unit in communication with said sensor;
a motorized drive controlled by said control unit, said motorized drive for changing said vehicle gate condition from an open state to a secured state; and
wherein said control unit has an automated state causing operation of said motorized drive and a disabled state disabling operation of said motorized drive, said control unit programmed to change from said disabled state to said automated state upon a predetermined condition relating to an output of said sensor.

2. The control system of claim 1 wherein said vehicle gate condition is a vehicle door condition.

3. The control system of claim 1 wherein said vehicle gate condition is a vehicle lift gate condition.

4. The control system of claim 1 wherein said control unit is programmed to change from said automated state to said disabled state and back to said automated state upon said predetermined condition.

5. The control system of claim 1 wherein said motorized drive is configured to drive a vehicle gate.

6. The control system of claim 1 wherein said motorized drive is configured to drive a vehicle latch.

7. The control system of claim 6 wherein said vehicle latch has a partially latched condition and a fully latched latch condition, said partially latch condition for triggering said motorized drive to advance said vehicle latch to said fully latch condition.

8. The control system of claim 7 wherein said automated state causes operation of said motorized drive from said partially latched condition to said fully latched condition and said disabled state prevents operation of said motorized drive from said partially latched condition to said fully latched condition.

9. The control system of claim 8 wherein said disabled state prevents said vehicle latch from entering said partially latched condition in addition to said fully latched condition.

10. The control system of claim 1 wherein said sensor senses vehicle gate movement.

11. The control system of claim 1 wherein said sensor senses vehicle gate position.

12. The control system of claim 1 wherein said motorized drive comprises a clutch and a motor.

13. The control system of claim 12 wherein said control unit is programmed to run said motor with said clutch disengaged from said motor while in said disabled state.

14. A control system for a vehicle gate, comprising:
a sensor for monitoring a vehicle gate condition between an opened condition and a closed condition;
a control unit in communication with said sensor;
a motorized drive controlled by said control unit, said motorized drive linked to drive a vehicle latch; and
wherein said control unit has an automated state causing operation of said motorized drive and a disabled state disabling operation of said motorized drive, said control unit programmed to change from said disabled state to said automated state upon a predetermined condition relating to an output of said sensor.

15. The control system of claim 14 wherein said vehicle latch has a partially latched condition and a fully latched latch condition, said partially latch condition for triggering said motorized drive to advance said vehicle latch to said fully latch condition and wherein said automated state causes operation of said motorized drive from said partially latched condition to said fully latched condition and said disabled state prevents operation of said motorized drive from said partially latched condition to said fully latched condition.

16. The control system of claim 15 wherein said disabled state prevents said vehicle latch from entering said partially latched condition in addition to said fully latched condition.

17. A control system for a vehicle gate, comprising:
a sensor for monitoring vehicle gate speed;
a control unit in communication with said sensor;
a motorized drive controlled by said control unit, said motorized drive linked to close a vehicle gate; and
wherein said control unit has an automated state causing operation of said motorized drive and a disabled state for disabling operation of said motorized drive, said control unit programmed to change from said disabled state to said automated state at a predetermined threshold relating to vehicle gate speed.

18. The control system of claim 17 wherein said control unit is programmed to change from said automated state to said disabled state and back to said automated state at said predetermined threshold relating to vehicle gate speed.

19. The control system of claim 17 wherein said motorized drive is maintained at a higher speed then said predetermined threshold relating to vehicle gate speed during said disabled state.
